(19) United States
(12) Patent Application Publication
(10) Pub. No.: US 2026/0063145 A1
(43) Pub. Date: Mar. 5, 2026

(54) FAN SHROUD ASSEMBLY AND CONTROL DEVICE INCLUDING THE SAME

(71) Applicant: HYUNDAI MOBIS CO., LTD., Seoul (KR)

(72) Inventors: Sung Hyun Park, Yongin-si (KR); Byung Mo Yu, Yongin-si (KR); Sun Jong Oh, Yongin-si (KR); Hyun Seong Lee, Yongin-si (KR); Kyeong Jun Lee, Yongin-si (KR); In Gun Kim, Yongin-si (KR)

(73) Assignee: HYUNDAI MOBIS CO., LTD., Seoul (KR)

(21) Appl. No.: 19/057,883

(22) Filed: Feb. 19, 2025

(30) Foreign Application Priority Data
Sep. 5, 2024 (KR) 10-2024-0120872

(51) Int. Cl. F04D 29/54; F04D 19/00; F04D 29/02; H01Q 1/22

(52) U.S. Cl. CPC F04D 29/541; F04D 19/002; F04D 29/023; H01Q 1/22

(57) ABSTRACT

Disclosed is a fan shroud assembly including a fan including a plurality of blades configured to rotate about a central shaft, and a shroud including a body having an air vent configured to face the fan and a contact part supported by radial supports. The fan shroud assembly is resistant to external impact without impeding signal transmission and reception of an antenna.

This application claims the benefit of Korean Patent Application No. 10-2024-0120872, filed on Sep. 5, 2024, which is hereby incorporated by reference as if fully set forth herein.

### BACKGROUND

### Field

The present disclosure relates to a fan shroud assembly and a control device including the same, and more particularly, to a fan shroud assembly having reinforced rigidity by applying the internal arrangement of a control device and a plastic shroud, and a control device including the same.

### Discussion of the Related Art

Vehicles are equipped with various control devices, and these devices perform various functions related to operation of the vehicles. Recently, as the performance and functions of these control devices have been improved, power consumption has increased and a resulting heat generation issue has occurred. In order to solve these problems, a fan to dissipate heat and a fan shroud to protect the fan are essentially used in the control devices.

The fan discharges heat in the control device to the outside to prevent the device from overheating, and the fan shroud protects the fan and controls the air flow to maintain effective cooling performance.

Conventional fan shrouds are mainly formed of metal and provide high rigidity and durability, but result in increased weight and manufacturing costs. In addition, metal materials may impede the radiation performance of an antenna integrated with the inside of the control device, thereby being capable of having a negative influence on communication quality.

Particularly, in the conventional fan shroud structure, fan deformation and shroud damage due to external impact may frequently occur. This may be caused by vibration or impact that occurs depending on road conditions while driving a vehicle, or accidental impact while parking. If the fan is deformed, the cooling performance may deteriorate rapidly, and heat in the control device is not effectively discharged and may cause overheating of the device.

The conventional fan shroud structure has a problem in that the rigidity of the entirety of the structure is reduced when the opening of the shroud is widened to improve the cooling performance, due to the trade-off between cooling performance and rigidity. On the other hand, when the material of the shroud is reinforced or the thickness of the structure is increased to increase the rigidity, the flow of cooling air is restricted, and thus the cooling performance decreases.

In order to solve these problems, there is a growing need for a fan shroud structure that is resistant to external impact while satisfying both rigidity and cooling performance.

### SUMMARY

In order to solve the above problems, embodiments of the present disclosure provide a fan shroud assembly that is resistant to external impact and has little deformation.

In addition, embodiments of the present disclosure provide a control device including a fan shroud assembly capable of maintaining rigidity without impeding antenna performance.

Technical tasks obtainable from the present disclosure are non-limited by the above-mentioned technical tasks. And, other unmentioned technical tasks can be clearly understood from the following description by those having ordinary skill in the technical field to which the present disclosure pertains.

Additional advantages, objects, and features of the disclosure will be set forth in the disclosure herein as well as the accompanying drawings. Such aspects may also be appreciated by those skilled in the art based on the disclosure herein.

A fan shroud assembly according to an embodiment of the present disclosure includes a fan including a plurality of blades configured to rotate about a central shaft, and a shroud including a body having an air vent configured to face the fan and a contact part supported by radial supports configured to extend in a centripetal direction from an inner circumferential surface of the air vent, wherein the contact part has a convex rear surface, and a thickest point of the contact part is in a straight line with the central shaft of the fan.

The fan may further include an outer frame configured to support the central shaft and surround the plurality of blades, and a rubber cover configured to cover the outer frame.

The shroud may be formed of a plastic material.

A control device according to another embodiment of the present disclosure includes a fan shroud assembly including a fan including a plurality of blades configured to rotate about a central shaft, and a shroud including a body having an air vent configured to face the fan and a plurality of supports configured to extend from an inner circumferential surface of the air vent, a housing configured such that the fan shroud assembly is mounted on one surface thereof, and a PCB mounted in the housing in a direction perpendicular to the fan shroud assembly, wherein the PCB is located so that one side portion thereof is adjacent to a rear portion of the fan to prevent the fan from being pushed by external force.

The shroud may further include a contact part supported by radial supports configured to extend in a centripetal direction from the inner circumferential surface of the air vent, the contact part may have a convex rear surface, and a thickest point of the contact part may be in a straight line with the central shaft of the fan.

The PCB may have a shape including a buffer groove formed in the side portion thereof to accommodate a portion of the fan.

The fan may further include an outer frame configured to support the central shaft and surround the plurality of blades, and a rubber cover configured to cover the outer frame.

The housing may include an anti-slip part configured to support the rubber cover to restrict movement of the fan due to the external force.

The control device may further include an antenna located in the housing, and the shroud may be formed of a plastic material configured not to interfere with a signal from the antenna.

The antenna may include a pattern antenna included in the PCB.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is an exploded perspective view showing a fan shroud assembly according to one embodiment of the present disclosure;

FIG. 2 is a perspective view showing a control device according to one embodiment of the present disclosure;

FIG. 3 is a cross-sectional view taken along line A-A′ of FIG. 2;

FIG. 4(a) and 4(b) are views for explaining the arrangement of components of the control device according to one embodiment of the present disclosure; and

FIG. 5 is a schematic enlarged view of a portion of the control device according to one embodiment of the present disclosure.

### DETAILED DESCRIPTION

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected to” another element, the element can be directly connected to the other element or intervening elements may also be present. In contrast, it will be understood that when an element is referred to as being “directly connected to”another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

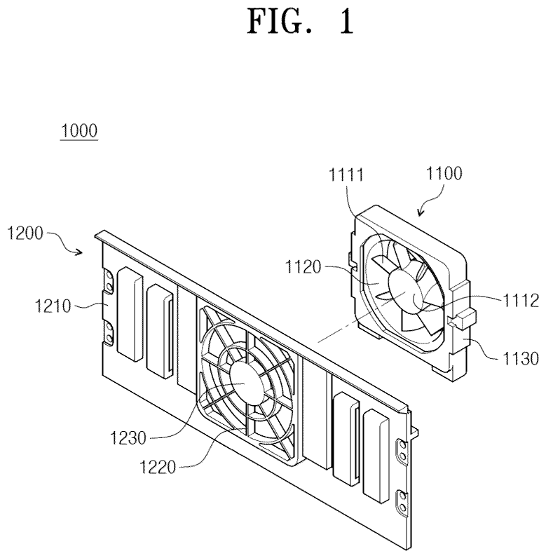

FIG. 1 is an exploded perspective view showing a fan shroud assembly according to one embodiment of the present disclosure. Hereinafter, the fan shroud assembly will be described in detail with reference to FIG. 1.

A fan shroud assembly 1000 according to one embodiment of the present disclosure may include a fan assembly (hereinafter, referred to as a “fan”) 1100 and a shroud 1200.

The fan 1100 may include a plurality of blades 1111 that rotates about a central shaft 1112. The blades 1111 may rotate to blow air in a control device, thereby being capable of performing a function of discharging heat to the outside. The fan 1100 may be provided as a general axial fan, and may provide air flow.

In addition, the fan 1100 may include an outer frame 1120 that supports the central shaft 1112 and surrounds the plurality of blades 1111. The outer frame 1120 serves to maintain the structural integrity of the fan 1100 and protect the blades 1111.

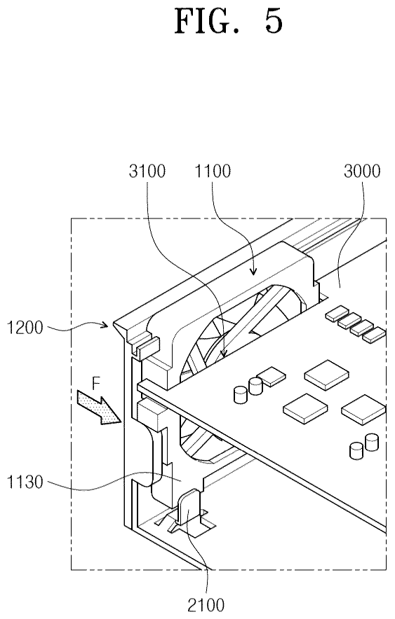

In addition, the outer frame 1120 may be covered with a rubber cover 1130, and the rubber cover 1130 may buffer external impact applied to the fan 1100 to prevent damage to the fan 1100. This configuration will be described later with reference to FIG. 5.

The shroud 1200 is coupled to the fan 1100 to increase the blowing efficiency of the fan 1100 and protect the fan 1100. The shroud 1200 may include a body 1210 and an air vent formed in the body 1210. The air vent may be formed at a position opposite to the position of the fan 1100.

The air vent may have radial supports 1220 which extend in the centripetal direction from the inner circumferential surface of the air vent, and the radial supports 1220 support a contact part 1230 within the shroud 1200.

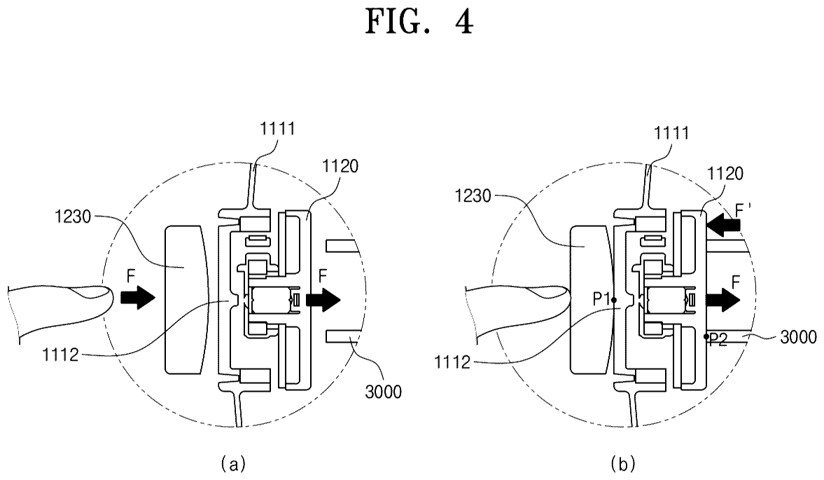

Referring to FIG. 4(a) and 4(b) together, the contact part 1230 is formed to have a convex rear surface, and is arranged so that a thickest point 1231 is in a straight line with the central shaft 1112 of the fan 1100. The shape of the contact part 1230 will be described later with reference to FIG. 4(a) and 4(b).

The shroud 1200 according to one embodiment of the present disclosure may be formed of a plastic material, which may prevent electromagnetic interference that may occur if the shroud is formed of a metal material, and may contribute to preventing impairment of antenna performance. In addition, the plastic material is advantageous in terms of weight reduction and has the advantage of reducing manufacturing costs.

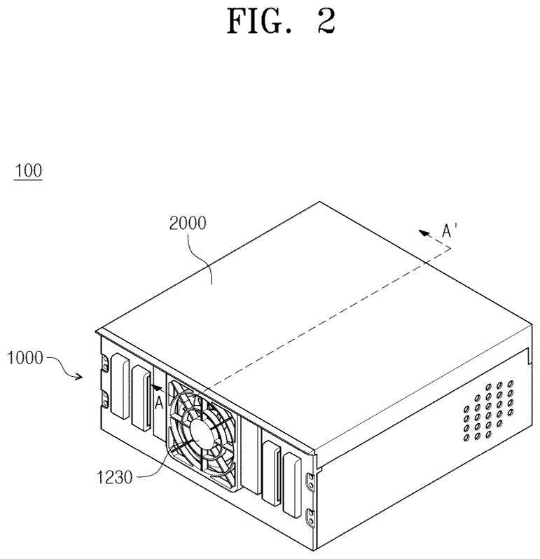

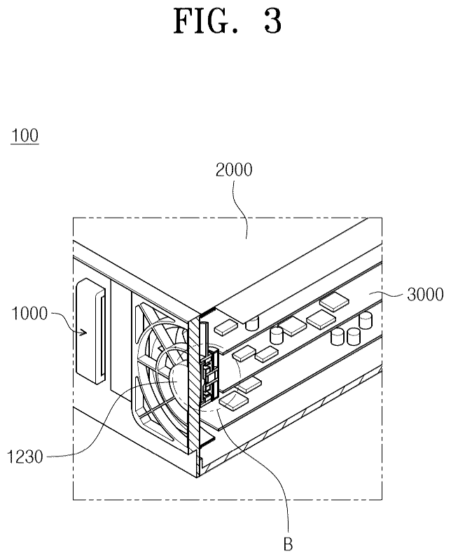

Hereinafter, a control device according to one embodiment of the present disclosure will be described in detail with reference to FIGS. 2 and 3. FIG. 2 is a perspective view showing the control device according to one embodiment of the present disclosure, and FIG. 3 is a cross-sectional view taken along line A-A′ of FIG. 2.

A control device 100 of FIG. 2 has the fan shroud assembly 1000 described above in FIG. 1. The control device 100 according to one embodiment of the present disclosure may include the fan shroud assembly 1000, a housing 2000, and PCBs 3000.

The fan shroud assembly 1000 includes the fan 1100 and the shroud 1200, and serves to discharge heat in the control device 100. The fan 1100 circulates air to prevent overheating of the control device 100, and the shroud 1200 is a component that protects the fan 1100 and regulates air flow.

The shroud 1200 has the contact part 1230 formed at a position facing the central portion of the fan 1100, and may be designed to prevent damage to the shroud 1200 and the fan 1100 that may occur due to external force through the contact part 1230. The contact part 1230 is aligned with a rotation axis of the fan 1100 and serves to stably support the shroud 1200 when external force is applied.

The contact part 1230 may be designed to have the convex rear surface so as to be supported by the fan 1100 even when external force (see FIG. 4(a) and 4(b)). The shroud 1200 may be also called a front cover, and is preferably manufactured as a molded product.

A metal shroud is generally used to reinforce rigidity, but in the present disclosure, a plastic material is used, and may thus provide excellent elasticity compared to metal. Therefore, the plastic material may have a low risk of being damaged due to impact, and exhibit flexibility while maintaining rigidity due to the characteristics of the material.

In addition, by using the plastic material, the thickness of the shroud 1200 itself may be increased to secure rigidity. Here, the thickness of the shroud 1200 is preferably 3 mm or more. Therefore, by using the plastic material, the opening of the shroud 1200 may be widened to improve cooling performance while securing rigidity.

The housing 2000 is an outer case of the control device 100, and serves to protect main components in the control device 100 and to maintain the overall structure of the control device 100. The fan shroud assembly 1000 may be mounted on one side surface of the housing 2000, and heat in the control device 100 is discharged through the fan shroud assembly 1000.

The housing 2000 may be designed to accommodate electronic components, such as the PCBs 3000 and protect internal components from impact or environmental factors. The housing 2000 may be manufactured through an aluminum die casting process.

In addition, the housing 2000 may include additional structural elements, such as an anti-slip part 2100 that serves to limit movement of the fan shroud assembly 1000 due to external impact (see FIG. 5).

The PCB 3000 is a printed circuit board, which is a core component of the control device 100, and various electronic components are mounted on the PCB 3000 to perform the functions of the control device 100. The PCB 3000 is a substrate that is generally used in electronic devices, and a detailed description thereof will be omitted in the present disclosure.

Referring to FIG. 3, the PCB 3000 is mounted in the housing 2000, and is arranged in a direction perpendicular to the fan shroud assembly 1000. Since the PCB 3000 is arranged perpendicular to the fan shroud assembly 1000, the rear portion of the fan 1100 and one side portion of the PCB 3000 are located adjacent to each other. This arrangement effectively restricts the movement of the fan 1100 in a situation in which the fan 1100 is pushed backward due to external impact. A plurality of PCBs 3000 may be provided.

Specifically, the rear surface of the fan 1100 may be in line contact with the side portion of the PCB 3000, and therethrough, the position of the fan 1100 may be fixed without being pushed backward further by the side portion of the PCB 3000 when external force is applied. That is, such line contact may suppress the backward movement of the fan 1100. The arrangement of the PCBs 3000 provides structural support within the housing 2000 to prevent the fan 1100 from being pushed backward due to external force and allow components in the control device 100 to maintain fixed positions thereof.

An antenna (not shown) may be located within the housing 2000, and is preferably provided as a pattern antenna included in the PCBs 3000. The antenna serves to transmit and receive electromagnetic signals in the housing 2000, and is in charge of the communication function of the control device 100.

The shroud 1200 may be formed of a plastic material to minimize electromagnetic interference even when the shroud 1200 is arranged at a position adjacent to the antenna (not shown). The shroud 1200 formed of the plastic material does not absorb or reflect electromagnetic waves unlike metal, and thus does not interfere with signal propagation of the antenna. Accordingly, the antenna enables smooth signal transmission and reception in the housing 2000.

In addition, the shroud 1200 formed of the plastic material may be elastically deformed by external force to protect the fan 1100 and the PCBs 3000. Also, the shroud 1200 may safely maintaining the internal components of the control device 100 without impeding the performance of the antenna.

FIG. 4(a) and 4(b) are views for explaining the arrangement of the components of the control device according to one embodiment of the present disclosure, i.e., enlarged views of portion B of FIG. 3. That is, these views are schematic enlarged views of a longitudinal section of the control device 100 taken around the center of the fan 1100 of the control device 100.

FIG. 4(a) shows the state of the fan and shroud assembly just before external force F is applied, and FIG. 4(b) shows the configuration relationship between the fan shroud assembly and the PCBs in a situation in which external force E is applied.

Referring to FIG. 4(a), a user may apply external force F to the center of the fan 1100 with an external object, such as a finger, and at this time, the external force acts in a direction indicated by an arrow. Such external force may occur mainly when installing the shroud 1200 or during a distribution process.

As described above in FIG. 1, the contact part 1230 that supports the central portion of the fan 1100 may have the convex rear surface, and be designed so that the thickest point 1231 of the contact part 1230 is in a straight line with the central shaft 1112 of the fan 1100. That is, a vertex of the rear surface of the contact part 1230 may be located in a straight line with the central shaft 1112 of the fan 1100, so that when external force is applied and the contact part 1230 is pushed backward, the contact part 1230 comes into point contact with the center of the fan 1100.

Further, the PCBs 3000 may be mounted perpendicularly at the rear of the fan 1100. The PCBs 3000 may be installed so that the rear surface of the fan 1100 and one side portion of each of the PCBs 3000 are adjacent to each other. Here, a distance between the fan 1100 and the PCBs 3000 is preferably 1 to 2 mm.

Referring to FIG. 4(b), when external force is applied to the central portion of the fan 1100, the contact part 1230 comes into contact with the central shaft 1112 of the fan 1100. Since the rear surface of the contact part 1230 is formed in a gently convex shape, point contact P1 is formed, and even if external force is applied, the contact part 1230 is pressed and pushed backward so that the rear surface thereof comes into contact with the central shaft 1112 of the fan 1100.

In other words, the thickest portion of the convex rear surface of the contact part 1230 comes into contact with the central shaft 1112 of the fan 1100, thereby forming the point contact P1. That is, such point contact P1 is located at a point where displacement is 0 even when the blades 1111 of the fan 1100 are rotating, and thus when external force is applied, the fan 1100 may maintain stability without moving or deforming the shaft 1112 of the fan 1100.

The contact part 1230 is supported by the fan 1100 and is no longer pushed backward, thereby being capable of preventing the shroud 1200 from being damaged.

Furthermore, if external force is applied more strongly, the fan 1100 may also move backward. In this situation, if the fan 1100 continues to move backward, there is a risk of structural damage occurring. However, since the PCBs 3000 are located perpendicularly adjacent to the rear portion of the outer frame 1120, the fan 1100 may be prevented from moving further backward.

The PCBs 3000 are located adjacent to the rear portion of the fan 1100 to form line contact P2 with the fan 1100, and the backward movement of the fan 1100 caused by external force may be restricted through the contact P2. The PCBs 3000 are firmly fixed in the control device 100, and may thus provide stable supporting force against external impact. The fan 1100 may no longer move backward through the line contact P2 with the PCBs 3000, and this contact P2 restricts the movement of the fan 1100.

The line contact P2 formed between the outer frame 1120 of the fan 1100 and the PCBs 3000 generates normal force F′ that acts in the opposite direction to the external force F when the fan 1100 is pushed backward by the external force F. The normal force F′ suppresses the positional change of the fan 1100, and prevents the fan 1100 from moving unnecessarily. Thereby, the displacement of the fan 1100 may be restricted, and structural damage to the fan 1100 due to external force may be prevented.

FIG. 5 is a schematic enlarged view of a portion of the control device according to one embodiment of the present disclosure, and illustrates a detailed configuration related to the rear surface of the fan.

Referring to FIG. 5, the PCB 3000 is arranged adjacent to the rear surface of the fan 1100, and a buffer groove 3100 is formed in the PCB 3000 to accommodate a portion of the fan 1100. The buffer groove 3100 is designed to accommodate the outer frame 1120 of the fan 1100, and serves to restrict the movement of the fan 1100 when the fan 1100 moves backward due to external force.

The buffer groove 3100 is formed so that the outer frame 1120 of the fan 1100 is in close contact with the PCB 3000 therethrough, and reduces a possibility that the fan 1100 will move backward. The buffer groove 3100 may be processed to have a specific depth and shape in one side surface of the PCB 3000, and thereby, the backward movement of the fan 1100 may be effectively restricted when external force is applied to the shroud 1200.

Referring to FIG. 5, the fan 1100 may be covered with the rubber cover 1130. The rubber cover 1130 serves to protect the outer surface of the fan 1100 and absorb shock. In addition, the rubber cover 1130 may be formed of an elastic material that provides flexibility so that the rubber cover 130 comes into contact with the PCB 3000 to be supported thereby when external force is applied and the fan 1100 moves backward.

In addition, the housing 2000 may include the anti-slip part 2100 that supports the rubber cover 1130 to restrict excessive movement of the fan 1100 due to external force F. The anti-slip part 2100 may be designed as a part integrated with the housing 2000, or be additionally installed as a separate part as needed.

As such, according to the above-described configuration, the present disclosure may effectively absorb and support external force applied to the fan, and stably maintain the position of the fan so that the components in the control device are not damaged by external impact. In addition, by using the plastic shroud, it is possible to maintain stable communication performance without impeding signal transmission and reception of the antenna.

As is apparent from the above description, according to one embodiment of the present disclosure, by using a plastic material, the communication quality of a control device may be maintained without impeding antenna performance.

According to one embodiment of the present disclosure, the structure of a fan shroud may be optimized to maintain rigidity of the fan shroud even against external impact.

According to one embodiment of the present disclosure, the existing components may be rearranged to increase rigidity, thereby being capable of increasing space utilization and conserving an installation space.

Effects that can be obtained from the present disclosure are not limited to the above-described effects, and other effects not mentioned herein will be clearly understood by those skilled in the art from the above description.

It is obvious to those skilled in the art that the present disclosure can be embodied in other specific forms without departing from the spirit and essential characteristics of the present disclosure.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

What is claimed is:

1. A fan shroud assembly comprising:
a fan comprising a plurality of blades configured to rotate about a central shaft; and
a shroud comprising a body having an air vent configured to face the fan and a contact part supported by radial supports configured to extend in a centripetal direction from an inner circumferential surface of the air vent,
wherein the contact part has a convex rear surface, and a thickest point of the contact part is aligned with the central shaft of the fan.

2. The fan shroud assembly according to claim 1, wherein the fan further comprises:
an outer frame configured to support the central shaft and surround the plurality of blades; and
a rubber cover configured to cover the outer frame.

3. The fan shroud assembly according to claim 1, wherein the shroud is formed of a plastic material.

4. A control device comprising:
a fan shroud assembly comprising a fan comprising a plurality of blades configured to rotate about a central shaft, and a shroud comprising a body having an air vent configured to face the fan and a plurality of supports configured to extend from an inner circumferential surface of the air vent;
a housing configured such that the fan shroud assembly is mounted on one surface thereof; and
a PCB mounted in the housing in a direction perpendicular to the fan shroud assembly,
wherein the PCB is located so that one side portion thereof is adjacent to a rear portion of the fan to prevent the fan from being pushed by external force.

5. The control device according to claim 4, wherein the shroud further comprises a contact part supported by radial supports configured to extend in a centripetal direction from the inner circumferential surface of the air vent,
wherein the contact part has a convex rear surface, and a thickest point of the contact part is aligned with the central shaft of the fan.

6. The control device according to claim 4, wherein the PCB has a shape comprising a buffer groove formed in the side portion thereof to accommodate a portion of the fan.

7. The control device according to claim 4, wherein the fan further comprises:
an outer frame configured to support the central shaft and surround the plurality of blades; and
a rubber cover configured to cover the outer frame.

8. The control device according to claim 7, wherein the housing comprises an anti-slip part configured to support the rubber cover to restrict movement of the fan due to the external force.

9. The control device according to claim 4, further comprising:
an antenna located in the housing,
wherein the shroud is formed of a plastic material configured not to interfere with a signal from the antenna.

10. The control device according to claim 9, wherein the antenna comprises a pattern antenna comprised in the PCB.
